(19) United States
(12) Patent Application Publication
(10) Pub. No.: US 2026/0045541 A1
(43) Pub. Date: Feb. 12, 2026

(54) NON-AQUEOUS ELECTROLYTIC SOLUTION FOR LITHIUM SECONDARY BATTERY, LITHIUM SECONDARY BATTERY PRECURSOR, METHOD FOR MANUFACTURING LITHIUM SECONDARY BATTERY, AND LITHIUM SECONDARY BATTERY

(71) Applicant: MITSUI CHEMICALS, INC., Chuo-ku, Tokyo (JP)

(72) Inventors: Yuki AGU, Chuo-ku, Tokyo (JP); Masahiro SUGURO, Chuo-ku, Tokyo (JP)

(73) Assignee: MITSUI CHEMICALS, INC., Chuo-ku, Tokyo (JP)

(21) Appl. No.: 19/102,727

(22) PCT Filed: Aug. 14, 2023
(86) PCT No.: PCT/JP2023/029471

§ 371 Date: Feb. 10, 2025

(30) Foreign Application Priority Data
Aug. 12, 2022 (JP) 2022-128895

(51) Int. Cl. H01M 10/0525; H01M 4/02; H01M 4/525; H01M 10/0567; H01M 10/44

(52) U.S. Cl. CPC H01M 10/0525; H01M 4/525; H01M 10/0567; H01M 10/446; H01M 2004/028; H01M 2300/0028

(57) ABSTRACT

One embodiment of the present invention provides a non-aqueous electrolytic solution for a lithium secondary battery, which can allow the rate of increase in normal-temperature resistance during high-temperature storage of a lithium secondary battery to be reduced. A non-aqueous electrolytic solution for a lithium secondary battery, the solution containing a compound (I), and an additive X being at least one selected from the group consisting of a compound (II) being at least one of a monofluorophosphate or a difluorophosphate, a compound (III), a compound (IV), and a compound (V). Each R¹¹ independently represents a fluoro group (—F), a chloro group (—Cl), a bromo group (—Br), or an iodo group (—I), and h represents an integer from 1 to 6.

### TECHNICAL FIELD

The present disclosure relates to a non-aqueous electrolytic solution for a lithium secondary battery, a lithium secondary battery precursor, a method of producing a lithium secondary battery, and a lithium secondary battery.

### BACKGROUND ART

In recent years, non-aqueous electrolytic solutions for lithium secondary batteries have been variously studied.

For example, Patent Literature 1 and 2 disclose a non-aqueous electrolytic solution for a lithium secondary battery, containing a bissulfonate ester compound of a specified structure.
Patent Literature 1: Chinese Patent Application Laid-Open (CN-A) No. 113782834
Patent Literature 2: CN-A No. 110668978

### SUMMARY OF INVENTION

### Technical Problem

However, the rate of increase in normal-temperature resistance of a lithium secondary battery in the case of high-temperature storage of the lithium secondary battery (hereinafter, also referred to as “rate of increase in normal-temperature resistance during high-temperature storage of a lithium secondary battery”) may be demanded to be more reduced.

An object of one aspect of the disclosure is to provide a non-aqueous electrolytic solution for a lithium secondary battery, a lithium secondary battery precursor, a lithium secondary battery, and a method of producing a lithium secondary battery, which can allow the rate of increase in normal-temperature resistance during high-temperature storage of a lithium secondary battery to be reduced.

### Solution to Problem

Solutions for solving the above problems include the following aspects.
<1> A non-aqueous electrolytic solution for a lithium secondary battery, the solution containing:
   a compound (I) represented by the following Formula (I); and
   an additive X being at least one selected from the group consisting of a compound (II) being at least one of a monofluorophosphate or a difluorophosphate, a compound (III) represented by the following Formula (III), a compound (IV) represented by the following Formula (IV), and a compound (V) represented by the following Formula (V):

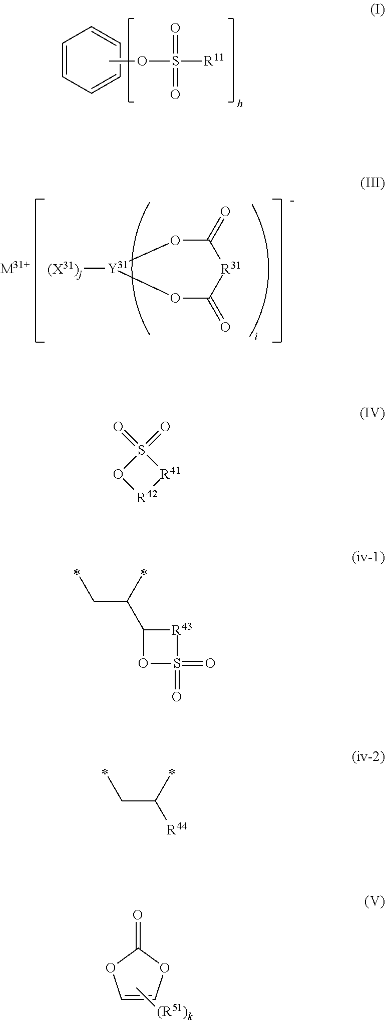

wherein, in Formula (I),
each R¹¹ independently represents a fluoro group (—F), a chloro group (—Cl), a bromo group (—Br), or an iodo group (—I), and
h represents an integer from 1 to 6,
in Formula (III),
M³¹⁺ represents an alkali metal ion,
each X³¹ independently represents a fluoro group (—F), a chloro group (—Cl), a bromo group (—Br), or an iodo group (—I),
Y³¹ represents a boron atom or a phosphorus atom,
each R³¹ independently represents a single bond (—), or a divalent hydrocarbon group having from 1 to 6 carbon atoms, optionally containing, as a substituent, at least one group selected from the group consisting of a fluoro group (—F), a chloro group (—Cl), a bromo group (—Br), and an iodo group (—I).
i represents 1 or 2 in a case in which the Y³¹ is a boron atom, or represents an integer from 1 to 3 in a case in which the Y³¹ is a phosphorus atom, and
j represents 0 or 2 in a case in which the Y³¹ is a boron atom, or represents 0, 2, or 4 in a case in which the Y³¹ is a phosphorus atom,
in Formula (IV),
R⁴¹ represents an oxa group (—O—) or a divalent hydrocarbon group having from 1 to 6 carbon atoms,
R⁴² represents a group represented by Formula (iv-1), a group represented by Formula (iv-2), or a divalent hydrocarbon group having from 1 to 6 carbon atoms, and
* represents a binding position,
in Formula (iv-1), R⁴³ represents an oxymethylene group (—OCH₂—), an oxyethylene group (—OCH₂CH₂—), an oxa group (—O—), or a divalent hydrocarbon group having from 1 to 6 carbon atoms, and
in Formula (iv-2), R⁴⁴ represents a hydrocarbon group having from 1 to 8 carbon atoms,
in Formula (V),
each R⁵¹ independently represents a fluoro group (—F), a hydrocarbon group having from 1 to 8 carbon atoms, optionally containing a fluoro group as a substituent, or a fluorocarbon group having from 1 to 8 carbon atoms, and
k represents an integer from 0 to 2.
<2> The non-aqueous electrolytic solution for a lithium secondary battery according to <1>, containing, as the additive X, at least one selected from the group consisting of the compound (II) and the compound (III).
<3> The non-aqueous electrolytic solution for a lithium secondary battery according to <1>, containing, as the additive X, at least one selected from the group consisting of the compound (II), the compound (IV), and the compound (V).
<4> The non-aqueous electrolytic solution for a lithium secondary battery according to <3>, containing, as the additive X, the compound (II), and at least one selected from the group consisting of the compound (IV) and the compound (V).
<5> The non-aqueous electrolytic solution for a lithium secondary battery according to <3>, containing, as the compound (IV), at least one selected from the group consisting of a compound (IV-1) represented by the following Formula (IV-1), a compound (IV-2) represented by the following Formula (IV-2), a compound (IV-3) represented by the following Formula (IV-3), a compound (IV-5) represented by the following Formula (IV-5), a compound (IV-6) represented by the following Formula (IV-6), a compound (IV-7) represented by the following Formula (IV-7), and a compound (IV-8) represented by the following Formula (IV-8).

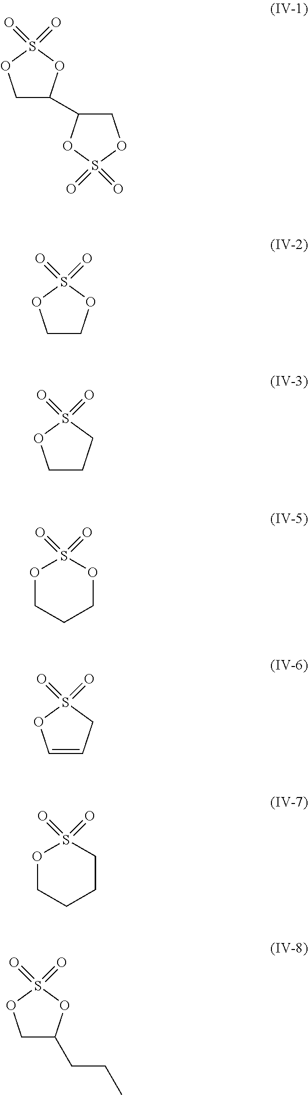

<6> The non-aqueous electrolytic solution for a lithium secondary battery according to <5>, containing, as the additive X, at least one selected from the group consisting of the compound (IV-1), the compound (IV-2), the compound (IV-3), the compound (IV-5), the compound (IV-6), the compound (IV-7), and the compound (IV-8), and at least one selected from the group consisting of the difluorophosphate and a compound (IV-4) represented by the following Formula (IV-4).

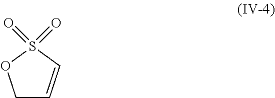

<7> The non-aqueous electrolytic solution for a lithium secondary battery according to <1>, containing the following compound (I-1) as the compound (I).

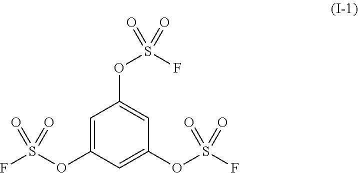 [SMILES: O=S(=O)(F)Oc1cc(OS(=O)(=O)F)cc(OS(=O)(=O)F)c1]

<8> The non-aqueous electrolytic solution for a lithium secondary battery according to any one of <1> to <7>, wherein a content of the compound (I) is from 0.01% by mass to 5.0% by mass with respect to a total amount of the non-aqueous electrolytic solution for a lithium secondary battery.
<9> The non-aqueous electrolytic solution for a lithium secondary battery according to any one of <1> to <8>, wherein a content of the additive X is from 0.01% by mass to 5.0% by mass with respect to a total amount of the non-aqueous electrolytic solution for a battery.
<10> A lithium secondary battery precursor including:
   a case; and
   a positive electrode, a negative electrode, a separator, and an electrolytic solution housed in the case, wherein
   the positive electrode is a positive electrode capable of occluding and releasing a lithium ion,
   the negative electrode is a negative electrode capable of occluding and releasing a lithium ion, and
   the electrolytic solution is the non-aqueous electrolytic solution for a lithium secondary battery according to any one of <1> to <9>.
<11> The lithium secondary battery precursor according to <10>, wherein the positive electrode includes, as a positive electrode active material, a lithium-containing composite oxide represented by the following Formula (P1):

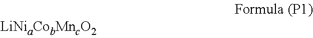

wherein, in Formula (P1), each of a, b and c is independently from more than 0 to less than 1, and a total of a, b and c is from 0.99 to 1.00.
<12> A method of producing a lithium secondary battery, the method including
   a step of preparing the lithium secondary battery precursor according to <10> or <11>, and
   a step of applying charge and discharge to the lithium secondary battery precursor.
<13> A lithium secondary battery obtained by applying charge and discharge to the lithium secondary battery precursor according to any one of <10> to <12>.

### Advantageous Effect of Invention

The disclosure provides a non-aqueous electrolytic solution for a lithium secondary battery, a lithium secondary battery precursor, a method of producing a lithium secondary battery, and a lithium secondary battery, in which the rate of increase in normal-temperature resistance during high-temperature storage of a lithium secondary battery can be reduced.

### BRIEF DESCRIPTION OF DRAWINGS

FIG. 1 is a schematic cross-sectional view illustrating a laminate-type battery as one example of the lithium secondary battery precursor of the disclosure.

FIG. 2 is a schematic cross-sectional view illustrating a coin-type battery as another example of the lithium secondary battery precursor of the disclosure.

### DESCRIPTION OF EMBODIMENTS

Herein, a numerical value range expressed with “(from) . . . to” means a range including numerical values described before and after “to” respectively as the lower limit value and the upper limit value.

Herein, the amount of each component in a composition means the total amount of a plurality of substances corresponding to each component present in the composition in a case in which the plurality of substances are present in the composition, unless particularly noted.

Herein, the term “step” encompasses not only an independent step, but also a step which, even in the case of being not clearly distinguishable from any other step, can achieve a predefined object of the relevant step.

### [Non-Aqueous Electrolytic Solution for Lithium Secondary Battery]

Hereinafter, the non-aqueous electrolytic solution for a lithium secondary battery of the disclosure (hereinafter, also simply referred to as “non-aqueous electrolytic solution”) contains
a compound (I) represented by the following Formula (I), and
an additive X being at least one selected from the group consisting of a compound (II) being at least one of a monofluorophosphate or a difluorophosphate, a compound (III) represented by the following Formula (III), a compound (IV) represented by the following Formula (IV), and a compound (V) represented by the following Formula (V).

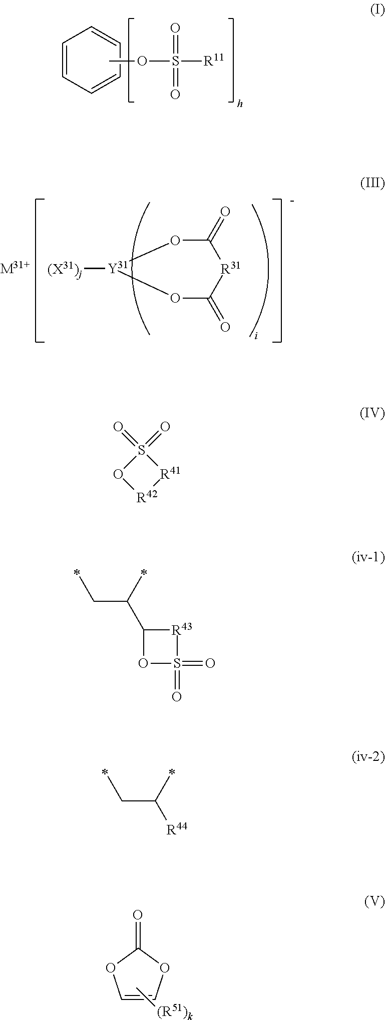

In Formula (I),
each R¹¹ independently represents a fluoro group (—F), a chloro group (—Cl), a bromo group (—Br), or an iodo group (—I), and
h represents an integer from 1 to 6.

In Formula (III),
M³¹⁺ represents an alkali metal ion,
each X³¹ independently represents a fluoro group (—F), a chloro group (—Cl), a bromo group (—Br), or an iodo group (—I),
Y³¹ represents a boron atom or a phosphorus atom,
each R³¹ independently represents a single bond (—), or a divalent hydrocarbon group having from 1 to 6 carbon atoms, optionally containing, as a substituent, at least one group selected from the group consisting of a fluoro group (—F), a chloro group (—Cl), a bromo group (—Br), and an iodo group (—I),
i represents 1 or 2 in a case in which the Y³¹ is a boron atom, or represents an integer from 1 to 3 in a case in which the Y³¹ is a phosphorus atom, and
j represents 0 or 2 in a case in which the Y³¹ is a boron atom, or represents 0, 2, or 4 in a case in which the Y³¹ is a phosphorus atom.

In Formula (IV),
R⁴¹ represents an oxa group (—O—) or a divalent hydrocarbon group having from 1 to 6 carbon atoms,
R⁴² represents a group represented by Formula (iv-1), a group represented by Formula (iv-2), or a divalent hydrocarbon group having from 1 to 6 carbon atoms, and
* represents a binding position,
in Formula (iv-1), R⁴³ represents an oxymethylene group (—OCH₂—), an oxyethylene group (—OCH₂CH₂—), an oxa group (—O—), or a divalent hydrocarbon group having from 1 to 6 carbon atoms, and
in Formula (iv-2), R⁴⁴ represents a hydrocarbon group having from 1 to 8 carbon atoms.

In Formula (V),
each R⁵¹ independently represents a fluoro group (—F), a hydrocarbon group having from 1 to 8 carbon atoms, optionally containing a fluoro group as a substituent, or a fluorocarbon group having from 1 to 8 carbon atoms, and
k represents an integer from 0 to 2.

According to the non-aqueous electrolytic solution of the disclosure, the rate of increase in normal-temperature resistance during high-temperature storage of a lithium secondary battery can be reduced.

In the disclosure, the normal-temperature resistance means the resistance under a normal temperature condition (for example, a condition of 25° C.).

In the disclosure, the rate of increase in normal-temperature resistance during high-temperature storage of a lithium secondary battery means the rate of increase in normal-temperature resistance of a lithium secondary battery in the case of high-temperature storage of the lithium secondary battery.

The rate of increase in normal-temperature resistance during high-temperature storage of a lithium secondary battery in the disclosure is determined as the ratio of the normal-temperature resistance after high-temperature storage of the lithium secondary battery to the normal-temperature resistance before high-temperature storage of the lithium secondary battery (namely, Ratio [Normal-temperature resistance after high-temperature storage of lithium secondary battery/Normal-temperature resistance before high-temperature storage of lithium secondary battery]).

The effects by the non-aqueous electrolytic solution of the disclosure are considered to be the effects obtained by a combination of
a compound (I), and
an additive X being at least one selected from the group consisting of a compound (II) being at least one of a monofluorophosphate or a difluorophosphate, a compound (III) represented by the following Formula (III), a compound (IV) represented by the following Formula (IV), and a compound (V) represented by the following Formula (V).

The reason why the above effects are exerted is considered because the compound (I) and the additive X are combined, thereby forming coating film(s) on electrode(s) (namely, positive electrode and/or negative electrode) in a lithium secondary battery, and such coating film(s) suppress(es) a side reaction such as decomposition of an electrolyte or a non-aqueous solvent in the non-aqueous electrolytic solution.

### <Compound (I)>

The non-aqueous electrolytic solution of the disclosure contains a compound (I) represented by the following Formula (I).

The non-aqueous electrolytic solution of the disclosure may contain only one, or two or more kinds of such compounds (I).

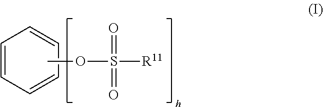

R¹¹ preferably represents a halogen atom, and specifically each thereof independently represents a “fluoro group (—F)”, a “chloro group (—Cl)”, a “bromo group (—Br)”, or an “iodo group (—I)”, and h represents an integer from 1 to 6.
R¹¹ particularly preferably represents a fluoro group (—F).
h represents an integer from 1 to 6, and h preferably represents 1, 2, or 3, still more preferably 2 or 3, particularly preferably 3.

Specific examples of the compound (I) include the following compound (I-1) and the following compound (I-2).

In particular, the following compound (I-1) is preferred.

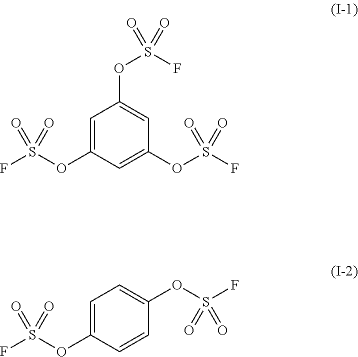 [SMILES: O=S(=O)(F)Oc1cc(OS(=O)(=O)F)cc(OS(=O)(=O)F)c1 ; O=S(=O)(F)Oc1ccc(OS(=O)(=O)F)cc1]

In a case in which the compound (I) in the non-aqueous electrolytic solution of the disclosure includes the compound (I-1), the proportion of the compound (I-1) in the compound (I) is usually from 50% by mass to 100% by mass, preferably 60% by mass or more, more preferably 70% by mass or more, still more preferably 80% by mass or more, particularly preferably 90% by mass or more.

The content of the compound (I) with respect to the total amount of the non-aqueous electrolytic solution of the disclosure is usually from 0.01% by mass to 5.0% by mass, and the lower limit value is preferably 0.05% by mass or more, more preferably 0.1% by mass or more, still more preferably 0.3% by mass or more and the upper limit value is preferably 4.0% by mass or less, more preferably 3.0% by mass or less, still more preferably 2.0% by mass or less, particularly preferably 1.5% by mass or less. The lower limit value can also be 0.8% by mass or more.

In a case in which a non-aqueous electrolytic solution taken by actually disassembling a lithium secondary battery is analyzed, the amount of the compound (I) may be decreased as compared with the amount thereof added to such a non-aqueous electrolytic solution. Also in this case, such a non-aqueous electrolytic solution taken from a lithium secondary battery is encompassed within the non-aqueous electrolytic solution of the disclosure as long as the compound (I) is detected even in a small amount in such a non-aqueous electrolytic solution.

The same also applies to other compounds (additive X and the like) described below.

### <Additive X>

The non-aqueous electrolytic solution of the disclosure contains an additive X.

The additive X is at least one selected from the group consisting of a compound (II) being at least one of a monofluorophosphate or a difluorophosphate, a compound (III) represented by the following Formula (III), a compound (IV) represented by the following Formula (IV), and a compound (V) represented by the following Formula (V).

The content of the additive X with respect to the total amount of the non-aqueous electrolytic solution of the disclosure is usually from 0.01% by mass to 5.0% by mass from the viewpoint of the effects by the non-aqueous electrolytic solution of the disclosure can be more effectively exerted, and the lower limit value is preferably 0.05% by mass or more, more preferably 0.1% by mass or more, still more preferably 0.3% by mass or more and the upper limit value is preferably 4.0% by mass or less, more preferably 3.0% by mass or less, still more preferably 2.0% by mass or less, particularly preferably 1.5% by mass or less. The lower limit value can also be 0.8% by mass or more.

The mass ratio of the content of the additive X to the content of the compound (I) in the non-aqueous electrolytic solution of the disclosure (hereinafter, also referred to as “content mass ratio [additive X/compound (I)]”) is usually from 0.1 to 10 from the viewpoint of the effects by the non-aqueous electrolytic solution of the disclosure can be more effectively exerted, and the lower limit value is preferably 0.2 or more, more preferably 0.5 or more, still more preferably 0.8 or more and the upper limit value is preferably 5.0 or less, more preferably 4.0 or less, still more preferably 3.0 or less.

### (Compound (II))

The compound (II) is at least one of a monofluorophosphate or a difluorophosphate.

The cation in the monofluorophosphate and the difluorophosphate is preferably a lithium ion (Li⁺), a sodium ion (Na⁺), or a potassium ion (K⁺), particularly preferably a lithium ion (Li⁺).

Specific examples of the compound (II) include the following compound (II-1) or the following compound (II-2).

The following compound (II-1) is lithium difluorophosphate and the following compound (II-2) is lithium monofluorophosphate.

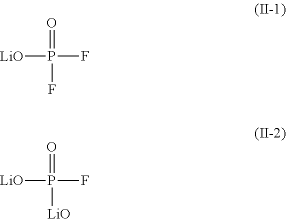

The compound (II) may correspond to only one of the monofluorophosphate or the difluorophosphate, or may correspond to both the monofluorophosphate and the difluorophosphate.

In a case in which the non-aqueous electrolytic solution of the disclosure contains the compound (II), the content of the compound (II) with respect to the total amount of the non-aqueous electrolytic solution is usually from 0.001% by mass to 5.0% by mass, and the lower limit value is preferably 0.05% by mass or more, more preferably 0.1% by mass or more, still more preferably 0.3% by mass or more and the upper limit value is preferably 4.0% by mass or less, more preferably 3.0% by mass or less, still more preferably 2.0% by mass or less, particularly preferably 1.5% by mass or less. The lower limit value can also be 0.8% by mass or more.

### (Compound (III))

The compound (III) is a compound represented by the following Formula (III).

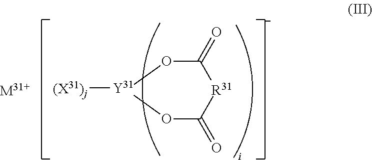

In Formula (III),
M³¹⁺ represents an “alkali metal ion”,
X³¹ preferably represents a halogen atom, and specifically each thereof independently represents a “fluoro group (—F)”, a “chloro group (—Cl)”, a “bromo group (—Br)”, or an “iodo group (—I)”,
Y³¹ represents a “boron atom” or a “phosphorus atom”,
each R³¹ independently represents a “single bond (—)” or a “divalent hydrocarbon group having from 1 to 6 carbon atoms, optionally containing, as a substituent, at least one group selected from the group consisting of a fluoro group (—F), a chloro group (—Cl), a bromo group (—Br), and an iodo group (—I)”.
i represents 1 or 2 in a case in which the Y³¹ is a boron atom, or represents an integer from 1 to 3 in a case in which the Y³¹ is a phosphorus atom, and
j represents 0 or 2 in a case in which the Y³¹ is a boron atom, or represents 0, 2, or 4 in a case in which the Y³¹ is a phosphorus atom.

While R³¹ may be a “single bond (—)”. R³¹ being a “single bond (—)” means that two carbonyl groups (>C═O) adjacent to R³¹ are directly bound, namely, means that an oxalate ion (C₂O₄²⁻) serves as a polydentate ligand to form an oxalate complex. The “divalent hydrocarbon group” means a hydrocarbon group preferably having from 1 to 10 carbon atoms, in particular, from 1 to 6 carbon atoms, and having two binding positions, is not limited to an aliphatic hydrocarbon group having a linear structure, and means that it may be a group having at least one structure selected from the group consisting of a branched structure, a cyclic structure, and a carbon-carbon unsaturated bond structure (carbon-carbon double bond structure or a carbon-carbon triple bond structure), or may be an aromatic hydrocarbon group. In other words, all of an alkylene group, an alkenylene group, an alkynylene group, an arylene group, and the like are encompassed in the “divalent hydrocarbon group”. The phrase “optionally containing, as a substituent, at least one group selected from the group consisting of a fluoro group (—F), a chloro group (—Cl), a bromo group (—Br), and an iodo group (—I)” means that not only a hydrocarbon group not containing a fluoro group (—F) or the like as a substituent is included, but also a hydrocarbon group (specifically, for example, alkyl halide having from 1 to 10 carbon atoms) is included in which some hydrogen atoms of such a hydrocarbon group are each substituted with any of a fluoro group (—F), a chloro group (—Cl), a bromo group (—Br), and an iodo group, provided that the respective numbers of fluoro groups (—F), chloro groups (—Cl), bromo groups (—Br), and iodo groups (—I), and any combination thereof are not particularly limited.

In a case in which R³¹ is a “divalent hydrocarbon group having from 1 to 6 carbon atoms, optionally containing, as a substituent, at least one group selected from the group consisting of a fluoro group (—F), a chloro group (—Cl), a bromo group (—Br), and an iodo group (—I)”, the number of carbon atoms in such a hydrocarbon group is preferably 5 or less, more preferably 4 or less, still more preferably 3 or less.
M³¹⁺ is preferably a lithium ion (Li⁺), a sodium ion (Na⁺), or a potassium ion (K⁺), particularly preferably a lithium ion (Li⁺).
X³¹ is preferably a fluoro group (—F) or a chloro group (—Cl), particularly preferably a fluoro group (—F).
Y³¹ represents a boron atom or a phosphorus atom, i represents 1 or 2 in a case in which Y³¹ is a boron atom, or represents an integer from 1 to 3 in a case in which Y³¹ is a phosphorus atom, and j represents 0 or 2 in a case in which Y³¹ is a boron atom, or represents 0, 2, or 4 in a case in which Y³¹ is a phosphorus atom, wherein, in a case in which Y³¹ is a boron atom, a combination of i and j is a combination of i=1 and j=2, or a combination of i=2 and j=0, and in a case in which Y³¹ is a phosphorus atom, a combination of i and j is a combination of i=1 and j=4, a combination of i=2 and j=2, or a combination of i=3 and j=0.
R³¹ is preferably a single bond (—), an alkylene group having from 1 to 6 carbon atoms, an alkenylene group having from 2 to 6 carbon atoms, an alkenylene group having from 2 to 6 carbon atoms, an alkylene group having from 1 to 6 carbon atoms, containing a fluoro group (—F), an alkenylene group having from 2 to 6 carbon atoms, containing a fluoro group (—F), or an alkynylene group having from 2 to 6 carbon atoms, containing a fluoro group (—F), preferably a single bond (—), a methylene group (—CH₂—), an ethylene group (—CH₂CH₂—), or a n-propylene group (—CH₂CH₂CH₂—), particularly preferably a single bond (—).

Specific examples of the compound (III) include the following compound (III-1) to the following compound (III-4).

The compound (III-1) is lithium bis(oxalato) borate (LiBOB), the compound (III-2) is lithium difluorooxalatoborate (LiDFOB), the compound (III-3) is lithium tetrafluorooxalatophosphate (LiTFOP), and the compound (III-4) is lithium difluorobis(oxalato)phosphate (LiDFBOP).

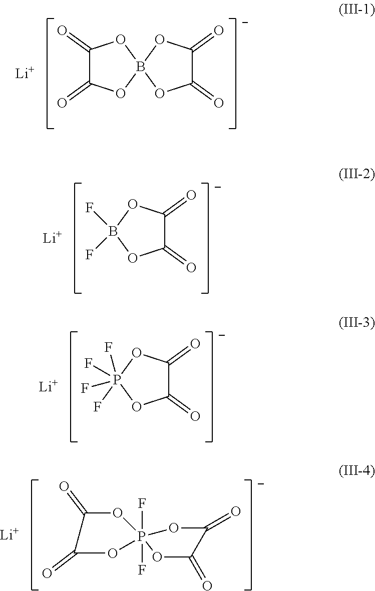

In a case in which the non-aqueous electrolytic solution of the disclosure contains the compound (III), the content of the compound (III) with respect to the total amount of the non-aqueous electrolytic solution is usually from 0.001% by mass to 5.0% by mass, and the lower limit value is preferably 0.05% by mass or more, more preferably 0.1% by mass or more, still more preferably 0.3% by mass or more and the upper limit value is preferably 4.0% by mass or less, more preferably 3.0% by mass or less, still more preferably 2.0% by mass or less, particularly preferably 1.5% by mass or less. The lower limit value can also be 0.8% by mass or more.

### (Compound (IV))

The compound (IV) is a compound represented by the following Formula (IV).

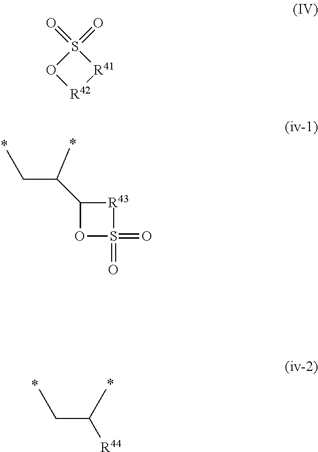

In Formula (IV),
R⁴¹ represents an “oxa group (—O—)” or a “divalent hydrocarbon group having from 1 to 6 carbon atoms”,
R⁴² represents a “group represented by Formula (iv-1)”, a “group represented by Formula (iv-2)”, or a “divalent hydrocarbon group having from 1 to 6 carbon atoms”, and
* represents a binding position,
in Formula (iv-1), R⁴³ represents an “oxymethylene group (—OCH₂—)”, an “oxyethylene group (—OCH₂CH₂—)”, an “oxa group (—O—)”, or a “divalent hydrocarbon group having from 1 to 6 carbon atoms”, and
in Formula (iv-2), R⁴⁴ represents a “hydrocarbon group having from 1 to 8 carbon atoms”.
R⁴¹ being an “oxa group (—O—)” means that an oxa group (—O—) is bound to each of a sulfonyl group (>S(═O)₂) and R⁴² to form a cyclic sulfate ester ( . . . S(═O)₂—O—R⁴²—O . . . ). In Formula (iv-1) and Formula (iv-2), * represents a “binding position”, and it means that each binding to an oxygen of Formula (IV) and to R⁴¹ at the * site is formed and, for example, in a case in which R⁴¹ is an “oxa group (—O—)” and R⁴² is a “group represented by Formula (iv-1)” or a “group represented by Formula (iv-2)”, a five-membered ring ( . . . S(═O)₂—O—CH₂—CHR—O . . . ) of ethylene sulfate is formed. The “divalent hydrocarbon group” has the same meaning as described above. R⁴³ being an “oxymethylene group (—OCH₂—)” means that an oxa group (—O—) of an oxymethylene group is bound with a sulfonyl group (>S(═O)₂) to form a five-membered ring ( . . . S(═O)₂—O—CH₂—CHR—O . . . ) of ethylene sulfate, R⁴³ being an “oxyethylene group (—OCH₂CH₂—)” means that such binding provides formation of a six-membered ring ( . . . S(═O)₂—O—CH₂—CH₂—CHR—O . . . ) of propylene sulfate, and R⁴³ being an “oxa group (—O—)” means that such binding provides formation of a four-membered ring ( . . . S(═O)₂—O—CHR—O . . . ) of methylene sulfate.

In a case in which R⁴¹ is a “divalent hydrocarbon group having from 1 to 6 carbon atoms”, the number of carbon atoms in the hydrocarbon group is preferably 5 or less, more preferably 4 or less.

In a case in which R⁴² is a “divalent hydrocarbon group having from 1 to 6 carbon atoms”, the number of carbon atoms in the hydrocarbon group is preferably 5 or less, more preferably 4 or less.

In a case in which R⁴³ is a “divalent hydrocarbon group having from 1 to 6 carbon atoms”, the number of carbon atoms in the hydrocarbon group is preferably 5 or less, more preferably 4 or less, still more preferably 3 or less, particularly preferably 2 or less.

R⁴⁴ is a “hydrocarbon group having from 1 to 8 carbon atoms”, and the number of carbon atoms in the hydrocarbon group is preferably 6 or less, more preferably 5 or less, still more preferably 4 or less, particularly preferably 3 or less.

R⁴¹ is preferably an oxy group (—O—), an alkylene group having from 1 to 6 carbon atoms, or an alkenylene group having from 2 to 6 carbon atoms, still more preferably an oxy group (—O—), a methylene group (—CH₂—), an ethylene group (—CH₂CH₂—), or an ethenylene group (—CH═CH—), particularly preferably an oxy group (—O—) or an ethenylene group (—CH═CH—).

R⁴² is preferably a group represented by Formula (iv-1), a group represented by Formula (iv-2), an alkylene group having from 1 to 6 carbon atoms, or an alkenylene group having from 2 to 6 carbon atoms, still more preferably a group represented by Formula (iv-1), a group represented by Formula (iv-2), a methylene group (—CH₂—), an ethylene group (—CH₂CH₂—), an ethenylene group (—CH═CH—), or a n-propylene group (—CH₂CH₂CH₂—), particularly preferably a group represented by Formula (iv-1) or a methylene group (—CH₂—).

R⁴³ is preferably an oxymethylene group (—OCH₂—), oxyethylene group (—OCH₂CH₂—), oxa group (—O—), an alkylene group having from 1 to 6 carbon atoms, or an alkenylene group having from 1 to 6 carbon atoms, still more preferably an oxymethylene group (—OCH₂—), an oxyethylene group (—OCH₂CH₂—), an oxa group (—O—), a methylene group (—CH₂—), an ethylene group (—CH₂CH₂—), or a n-propylene group (—CH₂CH₂CH₂—), particularly preferably an oxymethylene group (—OCH₂—).

R⁴⁴ is preferably an alkyl group having from 1 to 8 carbon atoms, an alkenyl group having from 2 to 8 carbon atoms, an alkynyl group having from 2 to 8 carbon atoms, or an aryl group having from 6 to 8 carbon atoms, methyl group (—CH₃), still more preferably an ethyl group (—CH₂CH₃), a vinyl group (—CH═CH₂), an n-propyl group (—CH₂CH₂CH₃), an n-butyl group (—CH₂CH₂CH₂CH₃), or a phenyl group (—C₆H₅), particularly preferably a methyl group (—CH₃), an ethyl group (—CH₂CH₃), a vinyl group (—CH═CH₂), or an n-propyl group (—CH₂CH₂CH₃).

Specific examples of the compound (IV) include the following compound (IV-1) to the following compound (IV-8), and the compound (IV-1), the compound (IV-2), the compound (IV-3), the compound (IV-5), the compound (IV-6), the compound (IV-7), or the compound (IV-8) is preferred. The compound (IV-4) is particularly preferably used in combination with at least one selected from the group consisting of the compound (IV-1), the compound (IV-2), the compound (IV-3), the compound (IV-5), the compound (IV-6), the compound (IV-7), and the compound (IV-8).

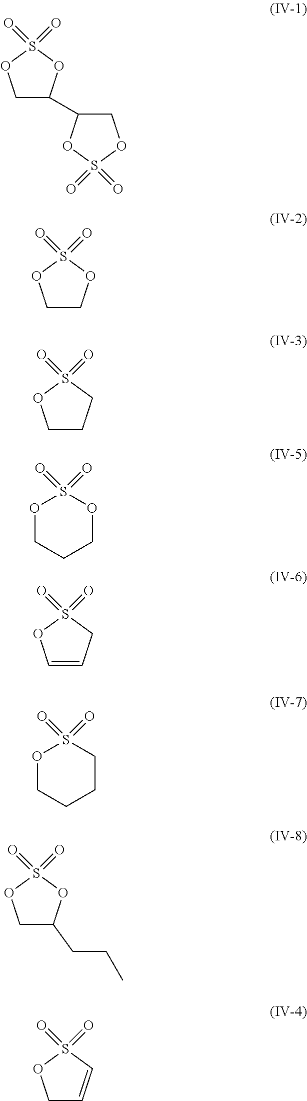

In a case in which the non-aqueous electrolytic solution of the disclosure contains the compound (IV), the content of the compound (IV) with respect to the total amount of the non-aqueous electrolytic solution is usually from 0.001% by mass to 5.0% by mass, and the lower limit value is preferably 0.05% by mass or more, more preferably 0.1% by mass or more, still more preferably 0.3% by mass or more and the upper limit value is preferably 4.0% by mass or less, more preferably 3.0% by mass or less, still more preferably 2.0% by mass or less, particularly preferably 1.5% by mass or less. The lower limit value can also be 0.8% by mass or more.

### (Compound (V))

The compound (V) is a compound represented by the following Formula (V).

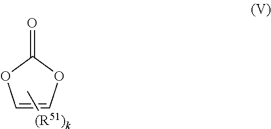

In Formula (V),
each R⁵¹ independently represents a “fluoro group (—F)”, a “hydrocarbon group having from 1 to 8 carbon atoms, optionally containing a fluoro group as a substituent”, or a “fluorocarbon group having from 1 to 8 carbon atoms”, and
k represents an integer from 0 to 2.

In Formula (V), a structure is drawn in which a binding line of (R⁵¹) k sticks a five-membered ring of vinylene carbonate, and this structure means that each of two hydrogen atoms contained in a five-membered ring ( . . . C(═O)—O—CH═CH—O . . . ) of vinylene carbonate is independently optionally substituted with a “fluoro group (—F)”, a “hydrocarbon group having from 1 to 8 carbon atoms, optionally containing a fluoro group (—F) as a substituent”, or a “fluorocarbon group having from 1 to 8 carbon atoms”. The “hydrocarbon group having from 1 to 8 carbon atoms, optionally containing a fluoro group as a substituent” has the same meaning as described above. The “fluorocarbon group” means a group in which all hydrogen atoms in a hydrocarbon group are substituted with fluoro groups (—F).

In a case in which R⁵¹ is a “hydrocarbon group having from 1 to 8 carbon atoms, optionally containing a fluoro group (—F) as a substituent” or a “fluorocarbon group having from 1 to 8 carbon atoms”, the number of carbon atoms of each of such hydrocarbon group and fluorocarbon group is preferably 6 or less, more preferably 5 or less, still more preferably 4 or less, particularly preferably 3 or less.

R⁵¹ is preferably a fluoro group (—F), an alkyl group having from 1 to 8 carbon atoms, an alkenyl group having from 2 to 8 carbon atoms, an alkynyl group having from 2 to 8 carbon atoms, an aryl group having from 6 to 8 carbon atoms, an alkyl group having from 1 to 8 carbon atoms, containing a fluoro group (—F), an alkenyl group having from 2 to 8 carbon atoms, containing a fluoro group (—F), an alkynyl group having from 2 to 8 carbon atoms, containing a fluoro group (—F), an aryl group having from 6 to 8 carbon atoms, containing a fluoro group (—F), a perfluoroalkyl group having from 1 to 8 carbon atoms, a perfluoroalkenyl group having from 2 to 8 carbon atoms, a perfluoroalkynyl group having from 2 to 8 carbon atoms, or a perfluoroaryl group having from 6 to 8 carbon atoms, particularly preferably a fluoro group (—F), a monofluoromethyl group (—CH₂F), a difluoromethyl group (—CHF₂), a trifluoromethyl group (—CF₃), a methyl group (—CH₃), or an ethyl group (—CH₂CH₃).
k is an integer from 0 to 2, preferably 0 or 1, particularly preferably 0. It is noted that k being 0 refers to no presence of R⁵¹ and means that vinylene carbonate is formed.

Specific examples of the compound (V) include the following compound (V-1).

The compound (V-1) is vinylene carbonate.

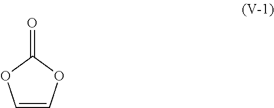

In a case in which the non-aqueous electrolytic solution of the disclosure contains the compound (V), the content of the compound (V) with respect to the total amount of the non-aqueous electrolytic solution is usually from 0.001% by mass to 5.0% by mass, and the lower limit value is preferably 0.05% by mass or more, more preferably 0.1% by mass or more, still more preferably 0.3% by mass or more and the upper limit value is preferably 4.0% by mass or less, more preferably 3.0% by mass or less, still more preferably 2.0% by mass or less, particularly preferably 1.5% by mass or less. The lower limit value can also be 0.8% by mass or more.

The additive X is at least one selected from the group consisting of a compound (II) being at least one of a monofluorophosphate or a difluorophosphate, a compound (III) represented by the following Formula (III), a compound (IV) represented by the following Formula (IV), and a compound (V) represented by the following Formula (V), and the non-aqueous electrolytic solution of the disclosure preferably contains two or more kinds of such additives X, or preferably contains three or more kinds of such additives X.

A preferred mode of the additive X is preferably a mode in which one, or two or more selected from the group consisting of the compound (II) and the compound (III) are contained, a mode in which one, or two or more selected from the group consisting of the compound (II), the compound (IV), and the compound (V) are contained, or a mode in which one, or two or more selected from the group consisting of the compound (II), the compound (IV), and the compound (V) are contained. Furthermore, a preferred mode of the additive X is preferably a mode in which one, or two or more selected from the group consisting of the compound (IV-1), the compound (IV-2), the compound (IV-3), the compound (IV-5), the compound (IV-6), the compound (IV-7), and the compound (IV-8), and one, or two or more selected from the group consisting of the difluorophosphate and the compound (IV-4) represented by Formula (IV-4) are contained.

In particular, in a case in which two or more such additives X are contained, a combination of such additives X is preferably a combination of the compound (II) and the compound (IV), particularly preferably a combination of lithium difluorophosphate and the compound (IV-1).

In a case in which three or more such additives X are contained, a combination of such additives X is preferably a combination of the compound (II), the compound (IV), and the compound (V), or a combination of the compound (II), the compound (IV-1), and the compound (IV-4), particularly preferably a combination of lithium difluorophosphate, the compound (IV-1), and the compound (V-1), or a combination of lithium difluorophosphate, the compound (IV-1), and the compound (IV-4).

### <Non-Aqueous Solvent>

The non-aqueous electrolytic solution generally contains a non-aqueous solvent. The non-aqueous solvent can be appropriately selected from various known solvents. The non-aqueous solvent may be adopted singly, or in combination of two or more kinds thereof.

Examples of the non-aqueous solvent include a cyclic carbonate compound, a fluorine-containing cyclic carbonate compound, a linear carbonate compound, a fluorine-containing linear carbonate compound, an aliphatic carboxylate ester compound, a fluorine-containing aliphatic carboxylate ester compound, a γ-lactone compound, a fluorine-containing γ-lactone compound, a cyclic ether compound, a fluorine-containing cyclic ether compound, a linear ether compound, a fluorine-containing linear ether compound, a nitrile compound, an amide compound, a lactam compound, nitromethane, nitroethane, sulfolane, trimethyl phosphate, dimethyl sulfoxide, or dimethyl sulfoxide/phosphate.

Examples of the cyclic carbonate compound include ethylene carbonate (EC), propylene carbonate (PC), or butylene carbonate (BC).

Examples of the fluorine-containing cyclic carbonate compound include fluoroethylene carbonate (FEC).

Examples of the linear carbonate compound include dimethyl carbonate (DMC), diethyl carbonate (DEC), ethyl methyl carbonate (EMC), methyl propyl carbonate (MPC), ethyl propyl carbonate (EPC), or dipropyl carbonate (DPC).

Examples of the aliphatic carboxylate ester compound include methyl formate, methyl acetate, methyl propionate, methyl butyrate, methyl isobutyrate, methyl trimethylbutyrate, ethyl formate, ethyl acetate, ethyl propionate, ethyl butyrate, ethyl isobutyrate, or ethyl trimethylbutyrate.

Examples of the γ-lactone compound include γ-butyrolactone or γ-valerolactone.

Examples of the cyclic ether compound include tetrahydrofuran, 2-methyltetrahydrofuran, tetrahydropyran, 1,3-dioxolane, 4-methyl-1,3-dioxolane, 1,3-dioxane, or 1,4-dioxane.

Examples of the linear ether compound include 1,2-ethoxyethane (DEE), ethoxymethoxyethane (EME), diethyl ether, 1,2-dimethoxyethane, or 1,2-dibutoxyethane.

Examples of the nitrile compound include acetonitrile, glutaronitrile, adiponitrile, methoxyacetonitrile, or 3-methoxypropionitrile.

Examples of the amide compound include N,N-dimethylformamide.

Examples of the lactam compound include N-methylpyrrolidinone, N-methyloxazolidinone, or N,N′-dimethylimidazolidinone.

The non-aqueous solvent preferably includes at least one carbonate-based compound selected from the group consisting of a cyclic carbonate compound, a fluorine-containing cyclic carbonate compound, a linear carbonate compound, and a fluorine-containing linear carbonate compound.

In this case, the total proportion of the cyclic carbonate compound, the fluorine-containing cyclic carbonate compound, the linear carbonate compound, and the fluorine-containing linear carbonate compound, with respect to the total amount of the non-aqueous solvent, is preferably from 50% by mass to 100% by mass, more preferably from 60% by mass to 100% by mass, still more preferably from 80% by mass to 100% by mass.

The non-aqueous solvent preferably includes at least one carbonate-based compound selected from the group consisting of a cyclic carbonate compound and a linear carbonate compound.

In this case, the total proportion of the cyclic carbonate compound and the linear carbonate compound in the non-aqueous solvent, with respect to the total amount of the non-aqueous solvent, is preferably from 50% by mass to 100% by mass, more preferably from 60% by mass to 100% by mass, still more preferably from 80% by mass to 100% by mass.

The upper limit of the content of the non-aqueous solvent, with respect to the total amount of the non-aqueous electrolytic solution, is preferably 99% by mass, preferably 97% by mass, still more preferably 90% by mass. The lower limit of the content of the non-aqueous solvent, with respect to the total amount of the non-aqueous electrolytic solution, is preferably 60% by mass or more, more preferably 70% by mass or more.

The intrinsic viscosity of the non-aqueous solvent is preferably 10.0 mPa's or less at 25° C. from the viewpoint of more enhancements in dissociation ability of an electrolyte and the mobility of ion.

### <Electrolyte>

The non-aqueous electrolytic solution generally contains an electrolyte.

The electrolyte preferably contains at least one of fluorine-containing lithium salt (hereinafter, sometimes referred to as “fluorine-containing lithium salt”.) or a fluorine-free lithium salt.

Examples of the fluorine-containing lithium salt include an inorganic acid anionic salt or an organic acid anionic salt.

Examples of the inorganic acid anionic salt include a lithium hexafluorophosphate (LiPF₆), lithium tetrafluoroborate (LiBF₄), lithium hexafluoroarsenate (LiAsF₆), or lithium hexafluorotantalate (LiTaF₆).

Examples of the organic acid anionic salt include lithium trifluoromethanesulfonate (LiCF₃SO₃), lithium bis(trifluoromethanesulfonyl)imide (Li(CF₃SO₂)₂N), or lithium bis(pentafluoroethanesulfonyl)imide (Li(C₂F₅SO₂)₂N).

In particular, the fluorine-containing lithium salt is still more preferably lithium hexafluorophosphate (LiPF₆).

Examples of the fluorine-free lithium salt include lithium perchlorate (LiClO₄), lithium tetrachloroaluminate (LiAlCH₄), or lithium decachlorodecabotaye (Li₂B₁₀Cl₁₀).

In a case in which the electrolyte contains the fluorine-containing lithium salt, the content rate of the fluorine-containing lithium salt with respect to the total amount of the electrolyte is preferably from 50% by mass to 100% by mass, more preferably from 60% by mass to 100% by mass, still more preferably from 80% by mass to 100% by mass.

In a case in which the fluorine-containing lithium salt contains lithium hexafluorophosphate (LiPF₆), the content rate of lithium hexafluorophosphate (LiPF₆) with respect to the total amount of the electrolyte is preferably from 50% by mass to 100% by mass, more preferably from 60% by mass to 100% by mass, still more preferably from 80% by mass to 100% by mass.

In a case in which the non-aqueous electrolytic solution contains the electrolyte, the concentration of the electrolyte in the non-aqueous electrolytic solution is preferably from 0.1 mol/L to 3 mol/L, more preferably from 0.5 mol/L to 2 mol/L.

In a case in which the non-aqueous electrolytic solution contains lithium hexafluorophosphate (LiPF₆), the concentration of lithium hexafluorophosphate (LiPF₆) in the non-aqueous electrolytic solution is preferably from 0.1 mol/L to 3 mol/L, more preferably from 0.5 mol/L to 2 mol/L.

### [Lithium Secondary Battery Precursor]

The lithium secondary battery precursor of the disclosure includes
a case, and
a positive electrode, a negative electrode, a separator, and an electrolytic solution housed in the case.

Herein,
the positive electrode is a positive electrode capable of occluding and releasing a lithium ion,
the negative electrode is a negative electrode capable of occluding and releasing a lithium ion, and
the electrolytic solution is the non-aqueous electrolytic solution of the disclosure (namely, the non-aqueous electrolytic solution according to the above first embodiment or second embodiment. The same applies to the following.).

In the disclosure, the lithium secondary battery precursor indicates a lithium secondary battery before application of charge and discharge.

According to the lithium secondary battery precursor of the disclosure, a lithium secondary battery obtained by applying charge and discharge to this lithium secondary battery precursor can be reduced in the rate of increase in normal-temperature resistance during high-temperature storage.

### <Case>

The shape or the like of the case is not particularly limited, and is appropriately selected depending on the application or the like of the lithium secondary battery precursor of the disclosure.

Examples of the case include a case including a laminate film, or a case including a battery can and a battery can lid.

### <Positive Electrode>

The positive electrode is a positive electrode capable of occluding and releasing a lithium ion.

The positive electrode preferably includes at least one positive electrode active material capable of occluding and releasing a lithium ion.

The positive electrode preferably includes a positive electrode current collector, and a positive electrode mixture layer provided on at least one portion of a surface of the positive electrode current collector.

Examples of the material of the positive electrode current collector include a metal or an alloy.

Specifically, examples of the material of the positive electrode current collector include aluminum, nickel, stainless steel material (SUS), or copper. In particular, aluminum is preferred from the viewpoint of the balance between the height of conductivity and the cost. The “aluminum” here means pure aluminum or an aluminum alloy. The positive electrode current collector is preferably aluminum foil. The material of the aluminum foil is not particularly limited, and examples thereof include an A1085 material or an A3003 material.

The positive electrode mixture layer preferably contains a positive electrode active material and a binder.

The positive electrode active material is not particularly limited as long as it is a substance capable of occluding and releasing a lithium ion, and can be appropriately adjusted depending on the application or the like of the lithium secondary battery precursor.

Examples of the positive electrode active material include a first oxide or a second oxide. The first oxide contains lithium (Li) and nickel (Ni) as constituent metal elements. The second oxide contains Li, Ni, and at least one metal element other than Li and Ni, as constituent metal elements. Examples of such a metal element other than Li and Ni include a transition metal element or a typical metal element. The second oxide preferably contains such a metal element other than Li and Ni at a proportion comparable with that of Ni or less than that of Ni in terms of the number of atoms. Such a metal element other than Li and Ni can be, for example, at least one selected from the group consisting of Co, Mn, Al, Cr, Fe, V. Mg, Ca, Na, Ti, Zr, Nb, Mo, W, Cu, Zn, Ga, In, Sn, La, and Ce. Such a positive electrode active material may be used singly, or in mixture of two or more kinds thereof.

The positive electrode active material preferably includes a lithium-containing composite oxide represented by the following Formula (P1) (hereinafter, sometimes referred to as “NCM”.). The lithium-containing composite oxide (P1) has the advantages of being high in energy density per unit volume and also being excellent in heat stability.

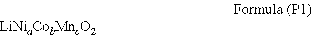

In Formula (P1), each of a, b and e is independently from more than 0 to less than 1, and the total of a, b and c is from 0.99 to 1.00.

Specific examples of NCM include LiNi_{0.33}Co_{0.33}Mn_{0.33}O₂, LiNi_{0.5}Co_{0.3}Mn_{0.2}O₂, LiNi_{0.5}Co_{0.2}Mn_{0.3}O₂, LiNi_{0.6}Co_{0.2}Mn_{0.2}O₂, or LiNi_{0.8}Co_{0.1}Mn_{0.1}O₂.

The positive electrode active material may include a lithium-containing composite oxide represented by the following Formula (P2) (hereinafter, sometimes referred to as “NCA”.).

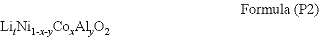

In Formula (P2), t is from 0.95 to 1.15, x is from 0 to 0.3, y is from 0.1 to 0.2, and the total of x and y is less than 0.5.

Specific examples of NCA include LiNi_{0.5}Co_{0.15}Al_{0.05}O₂.

In a case in which the positive electrode in the lithium secondary battery precursor of the disclosure includes the positive electrode current collector, and the positive electrode mixture layer including the positive electrode active material and the binder, the content of the positive electrode active material in the positive electrode mixture layer, with respect to the total amount of the positive electrode mixture layer, is preferably from 10% by mass to 99.9% by mass, more preferably from 30% by mass to 99.9% by mass, still more preferably from 50% by mass to 99% by mass, particularly preferably from 70% by mass to 99% by mass.

Examples of the binder include polyvinyl acetate, polymethyl methacrylate, nitrocellulose, a fluororesin, or a rubber particle. Examples of the fluororesin include polytetrafluoroethylene (PTFE), polyvinylidene fluoride (PVDF), a tetrafluoroethylene-hexafluoropropylene copolymer (FEP), or a vinylidene fluoride-hexafluoropropylene copolymer. Examples of the rubber particle include a styrene-butadiene rubber particle or an acrylonitrile nitrile rubber particle. In particular, a fluororesin is preferred from the viewpoint of enhancing oxidation resistance of the positive electrode mixture layer. The binder can be used singly, or, if necessary, in combination of two or more kinds thereof.

The content of the binder in the positive electrode mixture layer, with respect to the total amount of the positive electrode mixture layer, is preferably from 0.1% by mass to 4% by mass from the viewpoint that both physical properties of the positive electrode mixture layer (for example, electrolytic solution permeability and peeling strength) and battery performance are satisfied. In a case in which the content of the binder is 0.1% by mass or more, adhesiveness of the positive electrode mixture layer to the positive electrode current collector, and mutual binding ability of the positive electrode active material are more enhanced. In a case in which the content of the binder is 4% by mass or less, the amount of the positive electrode active material in the positive electrode mixture layer can be more increased and thus the discharge capacity is more enhanced.

The positive electrode mixture layer preferably includes a conductive aid.

A known conductive aid can be used as the material of the conductive aid. Such a known conductive aid is preferably a carbon material having conductivity. Examples of the carbon material having conductivity include graphite, carbon black, a conductive carbon fiber, or fullerene. Such a carbon material can be used singly, or in combination of two or more kinds thereof. Examples of the conductive carbon fiber include a carbon nanotube, a carbon nanofiber, or a carbon fiber. Examples of the graphite include artificial graphite or natural graphite. Examples of the natural graphite include scale-like graphite, lump graphite, or earthy graphite.

The material of the conductive aid may be a commercially available product. Examples of a commercially available product of carbon black include TOKABLACK #4300, #4400, #4500, #5500, or the like (furnace black, manufactured by Tokai Carbon Co., Ltd.), PRINTEX L or the like (furnace black, manufactured by Degussa AG), RAVEN 7000, 5750, 5250, 5000ULTRAIII, 5000ULTRA, or the like, CONDUCTEX SC ULTRA, CONDUCTEX 975ULTRA, or the like, PUER BLACK100, 115, 205 or the like (furnace black, manufactured by Columbian Chemicals), #2350, #2400B, #2600B, #30050B, #3030B, #3230B, #3350B, #3400B, #5400B or the like (furnace black, manufactured by Mitsubishi Chemical Corporation), MONARCH1400, 1300, 900, VulcanXC-72R, BLACKPEARLS 2000, LITX-50, LITX-200 or the like (furnace black, manufactured by Cabot), ENSACO 250G, ENSACO 260G, ENSACO 350G, SUPER-P (manufactured by TIMCAL Ltd.), KETJENBLACK EC-300J, EC-600JD (manufactured by Akzo Nobel N.V.), or DENKA BLACK HS-100, FX-35 (acetylene black, manufactured by Denka Co., Ltd.).

The positive electrode mixture layer may include any other component. Examples of such any other component include a thickener, a surfactant, a dispersant, a wetting agent, or a defoamer.

### <Negative Electrode>

The negative electrode is a negative electrode capable of occluding and releasing a lithium ion.

The negative electrode preferably includes at least one negative electrode active material capable of occluding and releasing a lithium ion.

The negative electrode preferably includes a negative electrode current collector, and a negative electrode mixture layer provided on at least one portion of a surface of the negative electrode current collector.

The material of the negative electrode current collector is not particularly limited, any known material can be used, and examples thereof include a metal or an alloy. Specifically, examples of the material of the negative electrode current collector include aluminum, nickel, a stainless steel material (SUS), a nickel-plated steel material, or copper. In particular, the material of the negative electrode current collector is preferably copper from the viewpoint of processability. The negative electrode current collector is preferably copper foil.

The negative electrode mixture layer preferably includes a negative electrode active material and a binder.

The negative electrode active material is not particularly limited as long as it is a substance capable of occluding and releasing a lithium ion. The negative electrode active material is preferably, for example, at least one selected from the group consisting of metal lithium, a lithium-containing alloy, a metal which can be alloyed with lithium, or a lithium alloy, an oxide with which a lithium ion can be doped and de-doped, a transition metal nitride with which a lithium ion can be doped and de-doped, and a carbon material with which a lithium ion can be doped and de-doped. In particular, the negative electrode active material is preferably a carbon material with which a lithium ion can be doped and de-doped (hereinafter, also simply referred to as “carbon material”.).

Examples of the carbon material include carbon black, activated carbon, a graphite material, or an amorphous carbon material. Such a carbon material may be used singly, or in mixture of two or more kinds thereof. The form of the carbon material is not particularly limited, and examples thereof include a fibrous, spherical, potato-shaped, or flake-shaped form. The particle size of the carbon material is not particularly limited, and is preferably from 5 μm to 50 μm, more preferably from 20 μm to 30 μm.

Examples of the amorphous carbon material include hard carbon, coke, meso-carbon microbeads (MCMB) fired at 1500° C. or less, or meso-phase pitch carbon fiber (MCF).

Examples of the graphite material include natural graphite or artificial graphite. Examples of the artificial graphite include graphitized MCMB or graphitized MCF. The graphite material may include boron. The graphite material may be covered with a metal or amorphous carbon. Examples of the material of the metal with which the graphite material is covered include gold, platinum, silver, copper, or tin. The graphite material may be a mixture of amorphous carbon and graphite.

The negative electrode mixture layer preferably includes a conductive aid. Examples of the conductive aid include the same conductive aid as the conductive aid exemplified as the conductive aid which can be included in the positive electrode mixture layer.

The negative electrode mixture layer may include, in addition to the above components, any other component. Examples of such any other component include a thickener, a surfactant, a dispersant, a wetting agent, or a defoamer.

### <Separator>

Examples of the separator include a porous resin flat plate. Examples of the material of the porous resin flat plate include a resin, or a non-woven fabric including this resin. Examples of the resin include polyethylene (PE), polypropylene (PP), polymethylpentene (PMP), polyester, cellulose, or polyamide.

In particular, the separator is preferably a porous resin sheet of a mono-layered or multi-layered structure. The material of the porous resin sheet mainly includes one, or two or more polyolefin resins. The thickness of the separator is preferably from 5 μm to 30 μm. The separator is preferably placed between the positive electrode and the negative electrode.

### <Specific Examples of Lithium Secondary Battery Precursor>

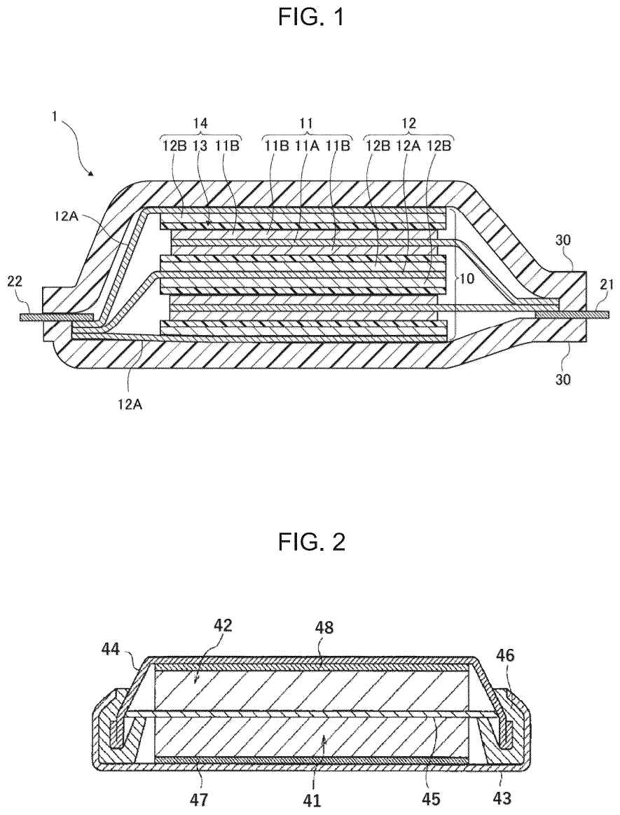

FIG. 1 is a schematic cross-sectional view illustrating a laminated-type lithium secondary battery precursor as one example of the lithium secondary battery precursor of the disclosure.

As illustrated in FIG. 1, a lithium secondary battery precursor 1 is a laminated-type battery precursor.

Specifically, a battery element 10 in the lithium secondary battery precursor 1 is encapsulated in an outer package 30. The outer package 30 is formed by a laminate film. Each of a positive electrode lead 21 and a negative electrode lead 22 is attached to the battery element 10. Each of the positive electrode lead 21 and the negative electrode lead 22 is leaded out in an opposite direction from the inside toward the outside of the outer package 30.

The battery element 10 is obtained by layering a positive electrode 11, a separator 13, and a negative electrode 12, as illustrated in FIG. 1. The positive electrode 11 is obtained by forming a positive electrode mixture layer 11B on each of both main surfaces of a positive electrode current collector 11A. The negative electrode 12 is obtained by forming a negative electrode mixture layer 12B on each of both main surfaces of a negative electrode current collector 12A. The positive electrode mixture layer 11B formed on one of the main surfaces of the positive electrode current collector 11A of the positive electrode 11, and the negative electrode mixture layer 12B formed on one of the main surfaces of the negative electrode current collector 12A of the negative electrode 12 adjacent to the positive electrode 11 face to each other with the separator 13 being interposed.

The non-aqueous electrolytic solution of the disclosure is injected to the inside of the outer package 30 of the lithium secondary battery precursor 1. The non-aqueous electrolytic solution of the disclosure penetrates in the positive electrode mixture layer 11B, the separator 13, and the negative electrode mixture layer 12B. In the lithium secondary battery precursor 1, one single battery layer 14 is formed by the adjacent positive electrode mixture layer 11B, separator 13, and negative electrode mixture layer 12B. Each of the positive electrode and the negative electrode may be one in which the active material layer is formed on one surface of the current collector.

The lithium secondary battery precursor 1 is a laminated-type lithium secondary battery precursor, and the lithium secondary battery precursor of the disclosure is not limited thereto and may be, for example, a wound-type lithium secondary battery precursor. The wound-type lithium secondary battery precursor is obtained by stacking and winding the positive electrode, the separator, the negative electrode, and the separator in the listed order in a layered manner. The wound-type lithium secondary battery precursor encompasses a cylindrical lithium secondary battery precursor and a rectangular lithium secondary battery precursor.

As illustrated in FIG. 1, the direction in which each of the positive electrode lead and the negative electrode lead is protruded from the inside toward the outside of the outer package 30 in the lithium secondary battery precursor 1 is an opposite direction against the outer package 30, but the disclosure is not limited thereto. For example, the method in which each of the positive electrode lead and the negative electrode lead is protruded from the inside toward the outside of the outer package 30 may be the same direction against the outer package 30.

One example of the lithium secondary battery of the disclosure, as described below, is a lithium secondary battery obtained by applying charge and discharge to the lithium secondary battery precursor 1.

FIG. 2 is a schematic cross-sectional view illustrating a coin-type lithium secondary battery precursor as another example of the lithium secondary battery precursor of the disclosure.

In a coin-type lithium secondary battery precursor illustrated in FIG. 2, a disk-shaped negative electrode 42, a separator 45 with the non-aqueous electrolytic solution injected thereinto, a disk-shaped positive electrode 41, and, if necessary, stainless or aluminum spacer plates 47 and 48, which are layered in the listed order, are received between a positive electrode can 43 (hereinafter, also referred to as “battery can”) and a sealing plate 44 (hereinafter, also referred to as “battery can lid”). The positive electrode can 43 and the sealing plate 44 are tightly sealed by swaging with a gasket 46 being interposed.

In such one example, the non-aqueous electrolytic solution of the disclosure is used as the non-aqueous electrolytic solution to be injected into the separator 45.

One example of the lithium secondary battery of the disclosure, as described below, is a lithium secondary battery obtained by applying charge and discharge to the coin-type lithium secondary battery precursor illustrated in FIG. 2.

### [Lithium Secondary Battery and Production Method Thereof]

The method of producing a lithium secondary battery of the disclosure includes
a step of preparing the above-mentioned lithium secondary battery precursor of the disclosure (hereinafter, also referred to as “preparation step”), and
a step of applying charge and discharge to the lithium secondary battery precursor.

The lithium secondary battery of the disclosure is a lithium secondary battery obtained by applying charge and discharge to the above lithium secondary battery precursor of the disclosure.

The lithium secondary battery and the production method thereof, of the disclosure, can allow for reduction in rate of increase in normal-temperature resistance during high-temperature storage of the lithium secondary battery.

The preparation step may be a step of only preparing the lithium secondary battery precursor of the disclosure, produced in advance, for the step of applying charge and discharge, or may be a step of producing the lithium secondary battery precursor of the disclosure.

The lithium secondary battery precursor is as described above.

The application of charge and discharge to the lithium secondary battery precursor in the step of applying charge and discharge can be performed according to a known method.

In this step, the application of a charge-discharge cycle to the lithium secondary battery precursor may be repeated multiple times.

As described above, such charge and discharge preferably allow a SEI (Solid Electrolyte Interface) film to be formed on surface(s) of the positive electrode (in particular, positive electrode active material) and/or the negative electrode (SEI (Solid Electrolyte Interface) film to be formed on a negative electrode active material) in the lithium secondary battery precursor.

The step of applying charge and discharge is preferably performed by applying a combination of charge and discharge to the lithium secondary battery precursor one or more times under an environment at 25° C. to 70° C.

### EXAMPLES

Hereinafter, Examples of the disclosure are shown, but the disclosure is not limited to the following Examples.

Hereinafter, “%” means “% by mass”, unless particularly noted.

### Comparative Example 1

### <Preparation of Non-Aqueous Electrolytic Solution>

Ethylene carbonate (hereinafter, “EC”), dimethyl carbonate (hereinafter, “DMC”), and ethyl methyl carbonate (hereinafter, “EMC”) were mixed at EC:DMC:EMC=30:35:35 (volume ratio). Thus, a mixed solvent was obtained as a non-aqueous solvent.

LiPF₆ as an electrolyte was dissolved in the obtained mixed solvent so that the concentration in a finally obtained non-aqueous electrolytic solution was 1 mol/L, and thus an electrolytic solution (hereinafter, also referred to as “basic electrolytic solution”) was obtained.

### <Production of Positive Electrode>

A mixture in which LiNi_{0.5}Co_{0.2}Mn_{0.3}O₂ (94% by mass) as the positive electrode active material, carbon black (3% by mass) as the conductive aid, and polyvinylidene fluoride (PVdF) (3% by mass) as a binding material were mixed was obtained. The obtained mixture was dispersed in an N-methylpyrrolidone solvent, to obtain a positive electrode mixture slurry.

Aluminum foil having a thickness of 20 μm was prepared as the positive electrode current collector.

The obtained positive electrode mixture slurry was applied onto the aluminum foil, dried, and rolled by a pressing machine, to obtain a sheet-shaped positive electrode. The positive electrode included the positive electrode current collector and a positive electrode active material layer.

### <Production of Negative Electrode>

Graphite (96% by mass) as the negative electrode active material, carbon black (1% by mass) as the conductive aid, 1% by mass in terms of solid content of sodium carboxymethylcellulose dispersed in pure water, as the thickener, and 2% by mass in terms of solid content of styrene-butadiene rubber (SBR) dispersed in pure water, as a binding material, were mixed, to obtain a negative electrode mixture slurry.

Copper foil having a thickness of 10 μm was prepared as the negative electrode current collector.

The obtained negative electrode mixture slurry was applied onto the copper foil, dried, and rolled by a pressing machine, to obtain a sheet-shaped negative electrode. The negative electrode included the negative electrode current collector and a negative electrode active material layer.

### <Preparation of Separator>

A porous polyethylene film was prepared as the separator.

### <Production of Lithium Secondary Battery Precursor>

The negative electrode, the positive electrode, and the separator were respectively punched into a disk shape having a diameter of 14 mm, a disk shape having a diameter of 13 mm, and a disk shape having a diameter of 17 mm. Thus, a coin-shaped negative electrode, a coin-shaped positive electrode, and a coin-shaped separator were respectively obtained.

The obtained coin-shaped negative electrode, coin-shaped separator, and coin-shaped positive electrode were layered in the listed order in a stainless battery can (size: 2032 size). Next, 28 μL of the non-aqueous electrolytic solution was injected into the battery can, and the separator, the positive electrode, and the negative electrode were impregnated with the non-aqueous electrolytic solution.

Next, an aluminum plate (thickness 1.2 mm, diameter 16 mm) and a spring were mounted on the positive electrode, and a battery can lid was swaged with a polypropylene gasket being interposed, to tightly seal a battery.

As described above, a coin-type lithium secondary battery precursor (namely, lithium secondary battery before application of charge and discharge) having a configuration illustrated in FIG. 2 was obtained. The size of the lithium secondary battery precursor had a diameter of 20 mm and a height of 3.2 mm.

### <Production of Lithium Secondary Battery>

A lithium secondary battery of Comparative Example 1 was obtained by applying to the lithium secondary battery precursor, charge at from 1.5 V to 4.2 V, retention at from 5 hours to 50 hours, charge to 4.2 V, and discharge to 2.5 V in the listed order under a temperature range of from 25° C. to 70° C.

### <Measurement of Initial Normal-Temperature Resistance>

The obtained lithium secondary battery of Comparative Example 1 was charged at 3.7 V, and then each amount of reduction in voltage (=Voltage before discharge initiation-Voltage at 10 seconds after discharge initiation) by CC10s discharge at each discharge rate of from 0.1 C to 0.6 C was measured in a constant-temperature bath in an environment at a temperature of 25° C. The CC10s discharge here means discharge performed at a constant current (Constant Current) for 10 seconds. The DC resistance [Ω] as the initial normal-temperature resistance was determined based on such each amount of reduction in voltage, obtained, and each current value (namely, each current value corresponding to each discharge rate of from 0.1 C to 0.6 C).

### <Measurement of Initial Low-Temperature Resistance>

The lithium secondary battery after measurement of the initial normal-temperature resistance was charged at 3.7 V, and then each amount of reduction in voltage (=Voltage before discharge initiation-Voltage at 10 seconds after discharge initiation) by CC10s discharge at each discharge rate of from 0.1 C to 0.6 C was measured in a constant-temperature bath in an environment at a temperature of −10° C. The CC10s discharge here means discharge performed at a constant current (Constant Current) for 10 seconds. The DC resistance [Ω] as the initial normal-temperature resistance was determined based on such each amount of reduction in voltage, obtained, and each current value (namely, each current value corresponding to each discharge rate of from 0.1 C to 0.6 C).

### <High-Temperature Storage>

Next, the lithium secondary battery after measurement of the initial low-temperature resistance was charged to 4.2 V, and the lithium secondary battery charged was retained in a constant-temperature bath at 60° C. for 14 days (hereinafter, defined as “high-temperature storage”).

<Measurement of Normal-Temperature Resistance after High-Temperature Storage>

The lithium secondary battery after high-temperature storage was discharged to 2.5 V, and then the normal-temperature resistance after high-temperature storage was measured by the same method as in measurement of the initial normal-temperature resistance.

<Measurement of Low-Temperature Resistance after High-Temperature Storage>

The lithium secondary battery measured with respect to the normal-temperature resistance after high-temperature storage was discharged to 2.5 V, and then the normal-temperature resistance after high-temperature storage was measured by the same method as in measurement of the initial normal-temperature resistance.

### Comparative Examples 2 and 3, and Examples 1 to 5

Compounds corresponding to specific examples of the above-mentioned compound (I), compound (II), compound (III), compound (IV), and compound (V) were each added as an additive to the above-mentioned basic electrolytic solution also used in the lithium secondary battery of Comparative Example 1 so that the content with respect to the total amount of a finally obtained non-aqueous electrolytic solution was a content described in Table 1, and thus non-aqueous electrolytic solutions to be used in lithium secondary batteries of Comparative Examples 2 and 3, and non-aqueous electrolytic solutions to be used in lithium secondary batteries of Examples 1 to 5 were each obtained. The same operation as in Comparative Example 1 was performed to prepare each of lithium secondary batteries of Comparative Examples 2 and 3, and lithium secondary batteries of Examples 1 to 5, the same operation as in Comparative Example 1 was performed, and “Measurement of Initial Normal-Temperature Resistance” and “Measurement of Initial Low-Temperature Resistance” were respectively performed. Furthermore, high-temperature storage was performed by the same operation as in Comparative Example 1, and “Measurement of Normal-Temperature Resistance after High-Temperature Storage” and “Measurement of Low-Temperature Resistance after High-Temperature Storage” were respectively performed. In Table 1, “-” means that the corresponding component is not contained. The compounds as specific examples of the compound (I), the compound (II), the compound (III), the compound (IV), and the compound (V) are the following compound (I-1), the following compound (I-2), the following compound (II-1), the following compound (III-1), the following compound (IV-1), the following compound (IV-4), and the following compound (V-1).

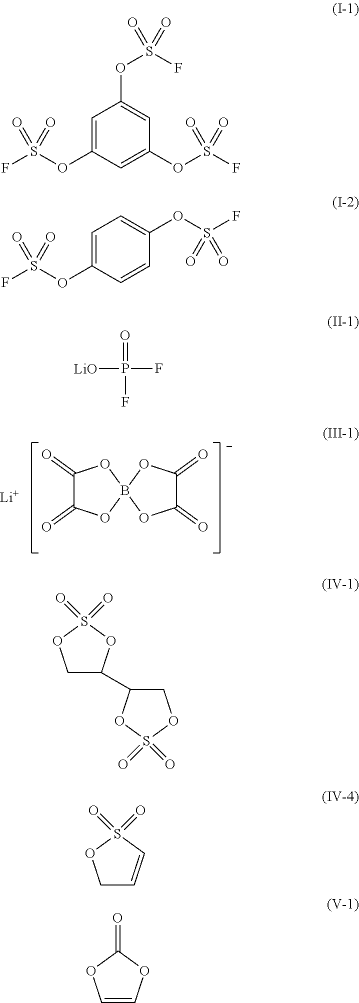

The respective relative values of the normal-temperature resistance value after high-temperature storage and the low-temperature resistance value after high-temperature storage of each of the lithium secondary batteries of Comparative Examples 2 and 3 and the lithium secondary batteries of Examples 1 to 5, under the assumption that the normal-temperature resistance value after high-temperature storage and the low-temperature resistance value after high-temperature storage of the lithium secondary battery of Comparative Example 1 were each 100, were calculated. The results are shown in Table 1.

TABLE 1

| | | | | | | | | Normal- | Low- |
|---|---|---|---|---|---|---|---|---|---|
| | | | | | | | | temperature | temperature |
| | | | | | | | | resistance | resistance |
| | | | | | | | | value after | value after |
| | | | | | | | | high- | high- |
| | | | Compound | Compound | | | Compound | temperature | temperature |
| | Compound (I) | | (II) | (III) | Compound (IV) | | (V) | storage | storage |
| | Compound | Compound | Compound | Compound | Compound | Compound | Compound | (relative | (relative |
| | (I-1) | (I-2) | (II-1) | (III-1) | (IV-1) | (IV-4) | (V-1) | value) | value) |
| Comparative | — | — | — | — | — | — | — | 100.0 | 100.0 |
| Example 1 | | | | | | | | | |
| Comparative | 0.5% by mass | — | — | — | — | — | — | 90.9 | 93.0 |
| Example 2 | | | | | | | | | |
| Comparative | — | 0.5% by | — | — | — | — | — | 94.0 | 96.0 |
| Example 3 | | mass | | | | | | | |
| Example 1 | 1.0% by mass | — | 1.0% by | — | — | — | — | 88.8 | 79.0 |
| | | | mass | | | | | | |
| Example 2 | 0.5% by mass | — | — | 0.5% by | — | — | — | 76.5 | 72.0 |
| | | | | mass | | | | | |
| Example 3 | 0.5% by mass | — | — | — | 0.5% by | — | — | 83.5 | 91.0 |
| | | | | | mass | | | | |
| Example 4 | 0.5% by mass | — | — | — | — | 0.5% by | — | 77.9 | 89.0 |
| | | | | | | mass | | | |
| Example 5 | 0.5% by mass | — | — | — | — | — | 0.5% by | 80.4 | 90.0 |
| | | | | | | | mass | | |

### Examples 6 to 9

Compounds corresponding to specific examples of the above-mentioned compound (I), compound (II), compound (III), compound (IV), and compound (V) were each added as an additive in the same manner as in Examples 1 to 5 so that the content with respect to the total amount of a finally obtained non-aqueous electrolytic solution was a content described in Table 2, and thus non-aqueous electrolytic solutions to be used in lithium secondary batteries of Example 6 to 9 were each obtained. The same operation as in Comparative Example 1 was performed to prepare each of lithium secondary batteries of Examples 6 to 9, the same operation as in Comparative Example 1 was performed, and “Measurement of Initial Normal-Temperature Resistance” and “Measurement of Initial Low-Temperature Resistance” were respectively performed. Furthermore, high-temperature storage was performed by the same operation as in Comparative Example 1, and “Measurement of Normal-Temperature Resistance after High-Temperature Storage” and “Measurement of Low-Temperature Resistance after High-Temperature Storage” were respectively performed. A compound (IV-8) as a specific example of the compound (IV) is the following.

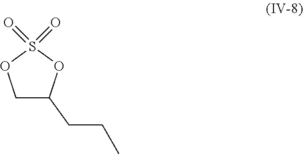

### <Calculation of Rate of Increase in Normal-Temperature Resistance During High-Temperature Storage and Rate of Increase in Low-Temperature Resistance During High-Temperature Storage>

The initial normal-temperature resistance value, the normal-temperature resistance value after high-temperature storage, the initial low-temperature resistance value, and the low-temperature resistance value after high-temperature storage of each of the lithium secondary batteries of Comparative Examples 1 to 3 and the lithium secondary batteries of Examples 1 to 9 were utilized, to calculate the rate (%) of increase in normal-temperature resistance during high-temperature storage and the rate (%) of increase in low-temperature resistance during high-temperature storage by the following expressions, respectively. The respective relative values of the rate of increase in normal-temperature resistance during high-temperature storage and the rate of increase in low-temperature resistance during high-temperature storage of each of the lithium secondary batteries of Comparative Examples 2 and 3 and the lithium secondary batteries of Examples 1 to 9, under the assumption that the rate of increase in normal-temperature resistance during high-temperature storage and the rate of increase in low-temperature resistance during high-temperature storage of the lithium secondary battery of Comparative Example 1 were each 100, were calculated. The results are shown in Table 2.

$$Rate ( \% ) of increase in normal - temperature resistance during high - temperature storage = ( Normal - temperature resistance value after high - temperature storage / Initial normal - temperature resistance value ) \times 100$$

$$Rate ( \% ) of increase in low - temperature resistance during high - temperature storage = ( Low - temperature resistance value after high - temperature storage / Initial low - temperature resistance value ) \times 100$$

TABLE 2

| | | | | | | | | | Rate of | Rate of |
|---|---|---|---|---|---|---|---|---|---|---|
| | | | | | | | | | increase | increase |
| | | | | | | | | | in | in |
| | | | | | | | | | normal- | low- |
| | | | | | | | | | temper- | temper- |
| | | | | | | | | | ature | ature |
| | | | | | | | | | resistance | resistance |
| | | | | | | | | | during | during |
| | | | | | | | | Com- | high- | high- |
| | | | | | | | | pound | temper- | temper- |
| | | | Compound | Compound | | | | (V) | ature | ature |
| | Compound (I) | | (II) | (III) | Compound (IV) | | | Com- | storage | storage |
| | Compound | Compound | Compound | Compound | Compound | Compound | Compound | pound | (relative | (relative |
| | (I-1) | (I-2) | (II-1) | (III-1) | (IV-1) | (IV-4) | (IV-8) | (V-1) | value) | value) |
| Comparative | — | — | — | — | — | — | — | — | 100.0 | 100.0 |
| Example 1 | | | | | | | | | | |
| Comparative | 0.5% by | — | — | — | — | — | — | — | 96.0 | 95.0 |
| Example 2 | mass | | | | | | | | | |
| Comparative | | 0.5% by | — | | — | — | — | — | 101.0 | 100.0 |
| Example 3 | | mass | | | | | | | | |
| Example 1 | 1.O% by | — | 1.0% by | | — | — | — | — | 86.0 | 85.0 |
| | mass | | mass | | | | | | | |
| Example 2 | 0.5% by | — | — | 0.5% by | — | — | — | — | 78.0 | 73.0 |
| | mass | | | mass | | | | | | |
| Example 3 | 0.5% by | — | — | — | 0.5% by | — | — | — | 87.0 | 92.0 |
| | mass | | | | mass | | | | | |
| Example 4 | 0.5% by | — | — | — | — | 0.5% by | — | — | 74.0 | 74.0 |
| | mass | | | | | mass | | | | |
| Example 5 | 0.5% by | — | — | — | — | — | — | 0.5% by | 89.0 | 90.0 |
| | mass | | | | | | | mass | | |
| Example 6 | 0.5% by | — | 0.5% by | — | 0.5% by | — | — | — | 77.7 | 63.7 |
| | mass | | mass | | mass | | | | | |
| Example 7 | 0.5% by | — | 0.5% by | — | 0.5% by | 0.5% by | — | — | 73.5 | 57.1 |
| | mass | | mass | | mass | mass | | | | |
| Example 8 | 0.5% by | — | 0.5% by | — | 0.5% by | — | 0.5% by | — | 87.8 | 72.3 |
| | mass | | mass | | mass | | mass | | | |
| Example 9 | 0.5% by | — | 0.5% by | — | 0.5% by | — | | 0.5% by | 77.7 | 67.8 |
| | mass | | mass | | mass | | | mass | | |

### <Measurement of Initial Capacity>

An aging operation in which charge and discharge between 2.5 V and 4.2 V were repeated twice in a constant-temperature bath at 25° C. was applied to each of the lithium secondary batteries of Comparative Example 1. Example 3, Example 6, Example 7, Example 8, and Example 9. Each of the lithium secondary batteries after aging was subjected to 4.2 V CC-CV charge at a charge rate of 0.2 C and 2.5 V CC discharge at a discharge rate of 0.2 C, and thus measurement of the initial capacity of each of the lithium secondary batteries was performed. The “CC-CV charge” means charge at a constant current and a constant volume (Constant Current-Constant Voltage). The “CC discharge” means discharge at a constant current (Constant Current),

### <Measurement of Initial Normal-Temperature Resistance>

Each of the lithium secondary batteries after measurement of the initial capacity was charged at 3.7 V, and then each amount of reduction in voltage (=Voltage before discharge initiation-Voltage at 10 seconds after discharge initiation) by CC10s discharge at each discharge rate of from 0.1 C to 0.6 C was measured in a constant-temperature bath in an environment at a temperature of 25° C. The CC10s discharge here means discharge performed at a constant current (Constant Current) for 10 seconds. The DC resistance [Ω] as the initial normal-temperature resistance was determined based on such each amount of reduction in voltage, obtained, and each current value (namely, each current value corresponding to each discharge rate of from 0.1 C to 0.6 C).

### <Measurement of Initial Low-Temperature Resistance>

Each of the lithium secondary batteries after measurement of the initial normal-temperature resistance was charged at 3.7 V, and then each amount of reduction in voltage (=Voltage before discharge initiation-Voltage at 10 seconds after discharge initiation) by CC10s discharge at each discharge rate of from 0.1 C to 0.6 C was measured in a constant-temperature bath in an environment at a temperature of −10° C. The CC10s discharge here means discharge performed at a constant current (Constant Current) for 10 seconds. The DC resistance [2] as the initial normal-temperature resistance was determined based on each amount of reduction in voltage obtained and each current value (namely, each current value corresponding to each discharge rate of from 0.1 C to 0.6 C).

### <Operation of High-Temperature Cycle>

Next, an operation including charge to 4.2 V at a constant current and a low voltage at a charge rate of 1 C and furthermore discharge to 2.5 V at a constant current at a discharge rate of 1 C at 55° C. was subjected 200 times to each of the lithium secondary batteries after measurement of the initial low-temperature resistance. (Hereinafter, defined as “high-temperature cycle”)

<Measurement of Capacity after High-Temperature Cycle>

Each of the lithium secondary batteries after a high-temperature cycle was charged to 4.2 V at a charge rate of 0.2 C at a constant current and a constant voltage (Constant Current-Constant Voltage), and discharged to 2.5 V at a discharge rate of 0.2C at a constant current (Constant Current), and thus the capacity after a high-temperature cycle was measured. The relative value of the capacity after a high-temperature cycle of each of the lithium secondary batteries of Example 3, Example 6, Example 7, Example 8, and Example 9, under the assumption that the capacity after a high-temperature cycle of the lithium secondary battery of Comparative Example 1 was 100, was calculated. The results are shown in Table 3.

<Measurement of Normal-Temperature Resistance after High-Temperature Cycle>

Each of the lithium secondary batteries, measured with respect to the capacity after a high-temperature cycle, was charged at 3.7 V, and then each amount of reduction in voltage (=Voltage before discharge initiation-Voltage at 10 seconds after discharge initiation) by CC10s discharge at each discharge rate of from 0.1 C to 0.6 C was measured in a constant-temperature bath in an environment at a temperature of 25° C. The CC10s discharge here means discharge performed at a constant current (Constant Current) for 10 seconds. The DC resistance [Ω] as the normal-temperature resistance after a high-temperature cycle was determined based on each amount of reduction in voltage obtained and each current value (namely, each current value corresponding to each discharge rate of from 0.1 C to 0.6 C).

<Measurement of Low-Temperature Resistance after High-Temperature Cycle>

Each of the lithium secondary batteries, measured with respect to the normal-temperature resistance after a high-temperature cycle, was charged at 3.7 V, and then each amount of reduction in voltage (=Voltage before discharge initiation-Voltage at 10 seconds after discharge initiation) by CC10s discharge at each discharge rate of from 0.1 C to 0.6 C was measured in a constant-temperature bath in an environment at a temperature of 25° C. The CC10s discharge here means discharge performed at a constant current (Constant Current) for 10 seconds. The DC resistance [Ω] as the low-temperature resistance after a high-temperature cycle was determined based on each amount of reduction in voltage obtained and each current value (namely, each current value corresponding to each discharge rate of from 0.1 C to 0.6 C).

<Calculation of Rate of Increase in Normal-Temperature Resistance and Rate of Increase in Low-Temperature Resistance during High-Temperature Cycle>

The initial normal-temperature resistance value, the normal-temperature resistance value after a high-temperature cycle, the initial low-temperature resistance value, and the low-temperature resistance value after a high-temperature cycle of each of the lithium secondary batteries of Comparative Example 1, Example 3, Example 6, Example 7, Example 8, and Example 9 were utilized, to calculate the rate (%) of increase in normal-temperature resistance during a high-temperature cycle and the rate (%) of increase in normal-temperature resistance during a high-temperature cycle by the following expressions, respectively. The respective relative values of the rate of increase in normal-temperature resistance during a high-temperature cycle and the rate of increase in low-temperature resistance during a high-temperature cycle of each of the lithium secondary batteries of Example 3, Example 6, Example 7, Example 8, and Example 9, under the assumption that the rate of increase in normal-temperature resistance and the rate of increase in low-temperature resistance of the lithium secondary battery of Comparative Example 1 were each 100, were calculated. The results are shown in Table 3.

Rate (%) of increase in normal-temperature resistance during high-temperature cycle=(Normal-temperature resistance after high-temperature cycle/Initial normal-temperature resistance)×100

Rate (%) of increase in low-temperature resistance during high-temperature cycle=(Low-temperature resistance value after high-temperature cycle/Initial low-temperature resistance)×100

### <Calculation of Capacity Retention Ratio During High-Temperature Cycle>

The initial capacity and the capacity after a high-temperature cycle of each of the lithium secondary batteries of Comparative Example 1, Example 3, Example 6, Example 7, Example 8, and Example 9 were utilized, to calculate the capacity retention ratio (%) during a high-temperature cycle of each of the lithium secondary batteries, by the following expression. The results are shown in Table 3.

$$Capacity retention ratio ( \% ) during high - temperature cycle = ( Capacity after high - temperature cycle ) / Initial capacity ) \times 100$$

TABLE 3

| | | | | | | | Rate of | Rate of | | |
|---|---|---|---|---|---|---|---|---|---|---|
| | | | | | | | increase | increase | | |
| | | | | | | | in | in | | |
| | | | | | | | normal- | low- | | |
| | | | | | | | temperature | temperature | | Capacity |
| | | | | | | | resistance | resistance | | retention |
| | | | | | | Com- | during | during | Capacity | ratio |
| | | | | | | pound | high- | high- | after | during |
| | Compound | Compound | | | | (V) | temperature | temperature | high- | high- |
| | (I) | (II) | Compound (IV) | | | Com- | cycle | cycle | temper- | temper- |
| | Compound | Compound | Compound | Compound | Compound | pound | (relative | (relative | ature | ature |
| | (I-1) | (II-1) | (IV-1) | (IV-4) | (IV-8) | (V-1) | value) | value) | cycle | cycle |
| Compar- | — | — | — | — | — | — | 100.0 | 100.0 | 100.0 | 70.76% |
| ative | | | | | | | | | | |
| Example 1 | | | | | | | | | | |
| Example 3 | 0.5% by | — | 0.5% by | — | — | — | 77.2 | 73.5 | 106.0 | 74.36% |
| | mass | | mass | | | | | | | |
| Example 6 | 0.5% by | 0.5% by | 0.5% by | — | — | — | 68.2 | 48.2 | 113.1 | 76.60% |
| | mass | mass | mass | | | | | | | |
| Example 7 | 0.5% by | 0.5% by | 0.5% by | 0.5% by | — | — | 75.9 | 56.9 | 111.5 | 79.71% |
| | mass | mass | mass | mass | | | | | | |
| Example 8 | 0.5% by | 0.5% by | 0.5% by | — | 0.5% by | — | 77.2 | 50.8 | 110.5 | 78.95% |
| | mass | mass | mass | | mass | | | | | |
| Example 9 | 0.5% by | 0.5% by | 0.5% by | — | — | 0.5% | 69.2 | 56.8 | 111.5 | 79.59% |
| | mass | mass | mass | | | by mass | | | | |

As shown in Table 1 to Table 3, it was revealed that each of the lithium secondary batteries of Examples 1 to 9, in which the non-aqueous electrolytic solution containing a combination of the compound (I) and the additive X was used, was low in normal-temperature resistance value after high-temperature storage and low-temperature resistance value after high-temperature storage, and excellent in rate of increase in normal-temperature resistance during high-temperature storage, rate of increase in low-temperature resistance during high-temperature storage, rate of increase in normal-temperature resistance during a high-temperature cycle, rate of increase in low-temperature resistance during a high-temperature cycle, capacity after a high-temperature cycle, and capacity retention ratio during a high-temperature cycle, as compared with the lithium secondary battery of Comparative Example 1.
1 lithium secondary battery precursor
10 battery element
11 positive electrode
11A positive electrode current collector
11B positive electrode mixture layer
12 negative electrode
12A negative electrode current collector
12B negative electrode mixture layer
13 separator
14 single battery layer
21 positive electrode lead
22 negative electrode lead
30 outer package
41 positive electrode
42 negative electrode
43 positive electrode can
44 sealing plate
45 separator
46 gasket
47, 48 spacer plate

The disclosure of Japanese Patent Application No. 2022-128895 filed on Aug. 12, 2022 is herein incorporated by reference in its entirety.

All documents, patent applications, and technical standards described herein are herein incorporated by reference, as if each individual document, patent application, and technical standard were specifically and individually indicated to be incorporated by reference.

1. A non-aqueous electrolytic solution for a lithium secondary battery, the solution comprising:
a compound (I) represented by the following Formula (I); and
an additive X that is at least one selected from the group consisting of a compound (II) that is at least one of a monofluorophosphate or a difluorophosphate, a compound (III) represented by the following Formula (III), a compound (IV) represented by the following Formula (IV), and a compound (V) represented by the following Formula (V): 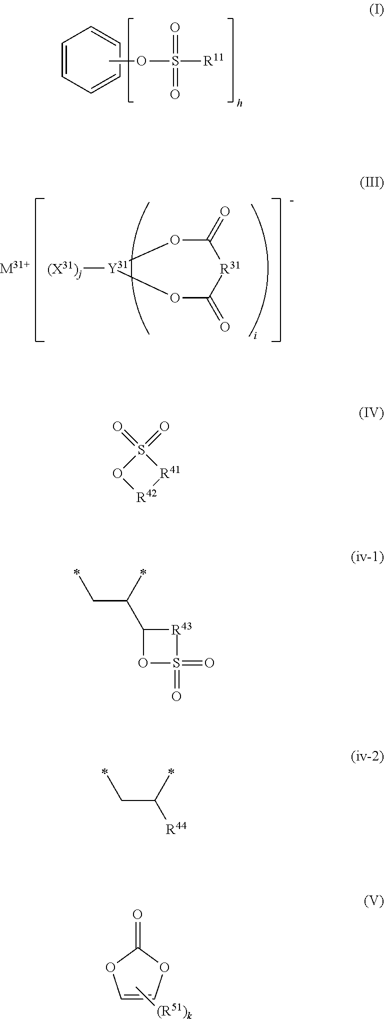
wherein, in Formula (I),
each R¹¹ independently represents a fluoro group (—F), a chloro group (—Cl), a bromo group (—Br), or an iodo group (—I), and
h represents an integer from 1 to 6,
in Formula (III),
M³¹⁺ represents an alkali metal ion,
each X³¹ independently represents a fluoro group (—F), a chloro group (—Cl), a bromo group (—Br), or an iodo group (—I),
Y³¹ represents a boron atom or a phosphorus atom,
each R³¹ independently represents a single bond (—), or a divalent hydrocarbon group having from 1 to 6 carbon atoms, optionally containing, as a substituent, at least one group selected from the group consisting of a fluoro group (—F), a chloro group (—Cl), a bromo group (—Br), and an iodo group (—I),
i represents 1 or 2 in a case in which the Y³¹ is a boron atom, or represents an integer from 1 to 3 in a case in which the Y³¹ is a phosphorus atom, and
j represents 0 or 2 in a case in which the Y³¹ is a boron atom, or represents 0, 2, or 4 in a case in which the Y³¹ is a phosphorus atom,
in Formula (IV),
R⁴¹ represents an oxa group (—O—) or a divalent hydrocarbon group having from 1 to 6 carbon atoms,
R⁴² represents a group represented by Formula (iv-1), a group represented by Formula (iv-2), or a divalent hydrocarbon group having from 1 to 6 carbon atoms, and
* represents a binding position,
in Formula (iv-1), R⁴³ represents an oxymethylene group (—OCH₂—), an oxyethylene group (—OCH₂CH₂—), an oxa group (—O—), or a divalent hydrocarbon group having from 1 to 6 carbon atoms, and
in Formula (iv-2), R⁴⁴ represents a hydrocarbon group having from 1 to 8 carbon atoms,
in Formula (V),
each R⁵¹ independently represents a fluoro group (—F), a hydrocarbon group having from 1 to 8 carbon atoms, optionally containing a fluoro group as a substituent, or a fluorocarbon group having from 1 to 8 carbon atoms, and
k represents an integer from 0 to 2.

2. The non-aqueous electrolytic solution for a lithium secondary battery according to claim 1, comprising, as the additive X, at least one selected from the group consisting of the compound (II) and the compound (III).

3. The non-aqueous electrolytic solution for a lithium secondary battery according to claim 1, comprising, as the additive X, at least one selected from the group consisting of the compound (II), the compound (IV), and the compound (V).

4. The non-aqueous electrolytic solution for a lithium secondary battery according to claim 3, comprising, as the additive X, the compound (II), and at least one selected from the group consisting of the compound (IV) and the compound (V).

5. The non-aqueous electrolytic solution for a lithium secondary battery according to claim 3, comprising, as the compound (IV), at least one selected from the group consisting of a compound (IV-1) represented by the following Formula (IV-1), a compound (IV-2) represented by the following Formula (IV-2), a compound (IV-3) represented by the following Formula (IV-3), a compound (IV-5) represented by the following Formula (IV-5), a compound (IV-6) represented by the following Formula (IV-6), a compound (IV-7) represented by the following Formula (IV-7), and a compound (IV-8) represented by the following Formula (IV-8):

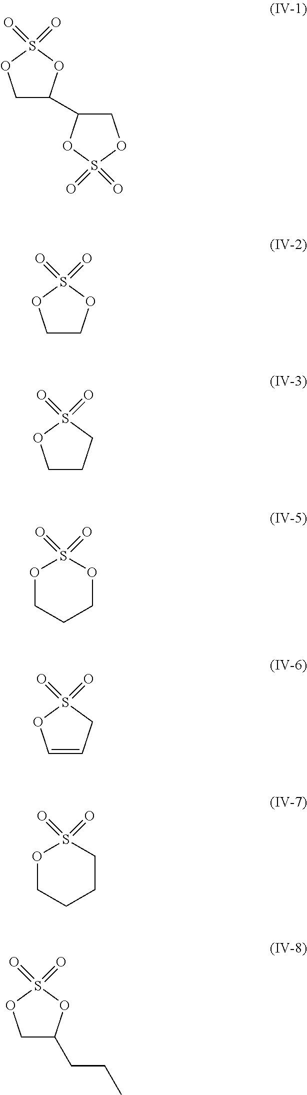

6. The non-aqueous electrolytic solution for a lithium secondary battery according to claim 5, comprising, as the additive X, at least one selected from the group consisting of the compound (IV-1), the compound (IV-2), the compound (IV-3), the compound (IV-5), the compound (IV-6), the compound (IV-7), and the compound (IV-8), and at least one selected from the group consisting of the difluorophosphate and a compound (IV-4) represented by the following Formula (IV-4):

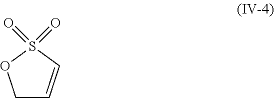

7. The non-aqueous electrolytic solution for a lithium secondary battery according to claim 1, comprising the following compound (I-1) as the compound (I):

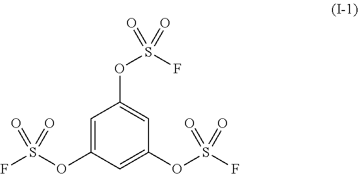 [SMILES: O=S(=O)(F)Oc1cc(OS(=O)(=O)F)cc(OS(=O)(=O)F)c1]

8. The non-aqueous electrolytic solution for a lithium secondary battery according to claim 1, wherein a content of the compound (I) is from 0.01% by mass to 5.0% by mass with respect to a total amount of the non-aqueous electrolytic solution for a lithium secondary battery.

9. The non-aqueous electrolytic solution for a lithium secondary battery according to claim 1, wherein a content of the additive X is from 0.01% by mass to 5.0% by mass with respect to a total amount of the non-aqueous electrolytic solution for a lithium secondary battery.

10. A lithium secondary battery precursor, comprising:
a case; and
a positive electrode, a negative electrode, a separator, and an electrolytic solution housed in the case, wherein:
the positive electrode is a positive electrode configured for occluding and releasing a lithium ion,
the negative electrode is a negative electrode configured for occluding and releasing a lithium ion, and
the electrolytic solution is the non-aqueous electrolytic solution for a lithium secondary battery according to claim 1.

11. The lithium secondary battery precursor according to claim 10, wherein the positive electrode comprises, as a positive electrode active material, a lithium-containing composite oxide represented by the following Formula (P1):
LiNiₐCo_{b}Mn_{c}O₂ Formula (P1):
wherein, in Formula (P1), each of a, b and c is independently from more than 0 to less than 1, and a total of a, b and c is from 0.99 to 1.00.

12. A method of producing a lithium secondary battery, the method comprising:
preparing the lithium secondary battery precursor according to claim 10; and
applying charge and discharge to the lithium secondary battery precursor.

13. A lithium secondary battery, obtained by applying charge and discharge to the lithium secondary battery precursor according to claim 10.
